(19) United States
(12) Patent Application Publication
(10) Pub. No.: US 2007/0149409 A1
(43) Pub. Date: Jun. 28, 2007

(54) Pesticide formulations with substituted biopolymers and organic polymers for improving residual activity, droplet size, adherence and rainfastness on leaves and reduction in soil leaching

(75) Inventors: Michael Burnet, Kusterdingen (DE); Jonathan B. Gressel, Rehovot (IL)

Correspondence Address: PALMER & DODGE, LLP;KATHLEEN M. WILLIAMS, 111 HUNTINGTON AVENUE, BOSTON, MA, 02199, US

(73) Assignee: Hi-Cap Formulations Ltd.

(21) Appl. No.: 11/476,479

(22) Filed: Jun. 27, 2006

Related U.S. Application Data
(63) Continuation-in-part of application No. PCT/US04/43949, filed on Dec. 29, 2004.
(60) Provisional application No. 60/532,582, filed on Dec. 29, 2003.

(51) Int. Cl. A01N 25/10; A01N 25/08

(52) U.S. Cl. 504/360; 424/410

(57) ABSTRACT

Functionalized polymers are mixed with pesticides to form semi-stable complexes with desirable field properties: reduced leaching in soil, improved leaf retention (rainfastness), selective unloading to roots and convenient packaging and application. Pesticides that may be so complexed include herbicides, insecticides (including compounds controlling non-insect arthropods and nematodes), bacteriocides, rodenticides, and fungicides. Polymers with which they may be complexed include derivatives of carbohydrates, amides, imines, alkanes, vinyls, styrenes or glycols. The polymers may be functionalized with chemical groups that exhibit ionic (amines, carboxyls), hydrophobic, complexing (e.g. metal chelating) and ligand binding interactions. The variously functionalized polymers may be mixed, grafted, or fused to obtain optimal properties. The polymer/pesticide formulations may be applied as granules, as suspensions or solutions in sprays, as foams, or as coats for seeds and fertilizers. The formulations may be applied to foliage, soil, irrigation water, construction materials (plastics, wood), seeding materials, grains, and buildings.

This application is a Continuation in part of International application serial number PCT/US2004/043949, filed Dec. 29, 2004, and which claims priority to U.S. provisional application 60/532,582, filed Dec. 29, 2003, the contents of which are incorporated by reference.

### FIELD OF THE INVENTION

This invention is in the field of pesticidal formulation and application. It builds on integrating principles of agronomy, soil science, and polymer chemistry in addition to agrochemistry, plant protection, and plant physiology.

### BACKGROUND OF THE INVENTION

The challenge in agrochemistry or other large scale field applications of chemicals such as herbicides, insecticides (including as herein defined compounds controlling non-insect arthropods as well as nematodes), bacteriocides, rodenticides, and fungicides (together defined as pesticides) is to find ways of achieving control of the target organism while limiting the amount of the xenobiotic substance that is loaded into and is free moving in the ecosystem by leaching or by aerosol drift. The amount of such chemicals that is required is a function of their potency, the ability to place the compound selectively and their susceptibility to removal either via destruction in the environment (metabolism, photolysis, etc.) or loss (leaching, drift). Unfortunately, environmentally desirable properties such as facile biodegradation or other loss may result in a need for frequent re-application and thus an increase in the load on the environment. Although there has been dramatic progress in identifying more pesticidally potent compounds for use in pest control there has been rather less success in controlling the application or placing of these chemicals in such a way as to limit losses and maximize efficacy.

Optimal placement has a critical role in the function of such compounds. For example, herbicides used in annual crops should retain activity at or near the soil surface to ensure that germinating weeds are exposed to the compound and controlled. These same compounds should not enter the subsoil water where they are more likely to be taken up by trees or other deep-rooted species resulting in generally undesirable off-target effects. This presents the agrochemist with somewhat of a paradox in that the properties that define many successful herbicides are exactly those that result in effects on and non-target species.

Similarly, systemic insecticides or fungicides would ideally be applied at seeding in small quantities that would remain with and protect the crop plant throughout its life cycle, however, for reasons of persistence, stability and economy, it is not generally feasible with available compounds and formulations to apply amounts at seeding that can provide the necessary long periods of control, especially as they are often applied as a seed dressing, and too high quantities can cause phytotoxicty to the crop, and excess can leach away into ecosystems.

In each of these examples, it may be possible to identify a compound that itself exhibits the desirable properties necessary to fulfill selective use and residual control criteria. However, the rising cost of discovering and registering new chemical entities is a significant barrier to finding new compounds to fit specific needs. Rather, the trend is to the reverse, making fewer, highly effective compounds serve a greater range of purposes. This in turn means that to make these compounds available and useful in a range of settings it will be necessary to pay more attention to the means of formulation and application.

A common goal of formulation, is to prevent aggregation of the active ingredient following dilution; another is to ensure that during mixing and packaging, the product remains uniform, flowable and non-accretive. Yet another goal of formulation is to govern droplet size such that small droplets will not drift off target. Formulation to enhance performance once applied to the target in the field is, however, less common.

Various limited examples of formulation for enhanced field performance are known in the art and include, amongst others, use of encapsulation, granulation, surfactants, stickers, control of droplet size and rheology, as well as humectants. Very rarely does a single compound perform more than one function: there are commercially available, separate sticking agents, separate humectants, separate compounds that control droplet size and again, separate slow release formulations. Most available slow release formulations are bulky, the ratio of formulant to herbicide is over 4 times the pesticide—often 10 to 50 times more. The polymeric and ionically-charged formulants described herein are never used at ratios of more than 4 times the pesticide, and some fill two or three of the other above functions.

A hitherto poorly explored area in pesticide chemistry, (meaning the fields of agronomy, soil science and polymer chemistry in addition to agrochemistry, plant protection and plant physiology) is, however, that of ion exchangers and other mixed function substituted biopolymers that have the capacity to retain and/or reversibly bind active ingredients. Such biopolymers can be selected to suit the properties and the applications of the associated compound and thus extend its range of uses consistent with the current need described above. Many can simultaneously perform many of the requirements of a formulant described above.

For example, anion or cation exchangers can be used to formulate appropriately charged insecticides and fungicides such that the compound is prevented from entering plants but instead remains on the leaf or fruit surface. The exchange material can be selected such that it only releases the active ingredient in the pH conditions found in the Lepidopteran gut or the formulant is enzymatically cleaved by an enzyme of the pathogen and thus can be made more selective and less likely to enter the mammalian food chain (such polymers being easily removed with water and surfactants).

The problems of achieving season-long control provide another example of the benefits of using tuned polymer formulations. Certain herbicides, for example, are anions or cations and thus highly water soluble. This means that they may not be used in residual control applications because they are readily washed off leaves or leached into soil beyond the desired activity zone by rainfall. This problem is typically solved by either applying a larger amount of herbicide to compensate for losses (expensive and potentially toxic to a crop and environmentally hazardous), applying a mixture (difficult to find combinations that have the same spectrum and crop safety) or making analogs with greater stability or soil binding (expensive to register and non-availability may reduce early season control). Alternatively, the herbicide may be formulated as an exchangeable form on a polymer backbone that exchanges the active ingredient steadily with soil ions throughout the season. Moreover, polymeric formulation provides even greater flexibility than this in that it allows the inclusion of multiple polymer types which for simplicity can be characterized as weak (e.g. primary amines), mild (e.g. secondary or tertiary amines) and strong exchangers (e.g. quaternary amines). Weak exchangers unload their active ingredient relatively easily and thus contribute to early season control. Mild exchangers have a longer half life of exchange and thus provide the bulk of the material through the mid season. Strong exchangers, logically, unload most slowly and thus ensure that appearance of the pest, as may happen later in the growing season are controlled without the need to spray doses of pesticide at the delicate stages of crop development such as flowering/anthesis/grain filling.

Although the usual rules and regulations of chemical use and registration limit flexibility of firms in launching new pesticides, they are far less restrictive on inert carriers that are a part of formulants insofar as they are known to be safe. Thus, it is possible to foresee a situation in which a user could lower the proportion of free pesticide (for initial or foliar effect) and alter the various exchangeable forms to their particular circumstances. Application of herbicides on rail tracks and other rights of way in northern Europe and other temperate climates may, for example, include more of a strong exchanger, while use in a low rainfall environment may need less strong exchanger and more of the weak and medium forms.

Biopolymers with high ion exchange capacity have been used extensively for water purification, separations of chemicals, pollutant binding, formulations of pharmaceuticals and fertilizers, but have not been reported for use as slow release formulants, penetrants, sticking agents, drop size controlling agents or humectants for pesticides.

A further advantage of non-covalent binding to polymer formulants is their potential utility as additives in point of use modification of a pesticide application. Thus, a user may select a polymeric adjuvant to add to a spray solution to modify its properties according to the needs of local conditions. This is especially feasible for more powerful exchangers that are capable of displacing common pesticide counter-ions.

A similar approach can be taken with fungicides, especially those where residual systemic activity is required. Polymeric formulations of fungicides can be incorporated into seed dressings or applied in furrow during seeding. Here properties of tuned slow release can be used to ensure that the fungicide has a longer duration of availability with equal or less active fungicide. Similarly, use of a polymer that unloads its active ingredient in the presence of hydrogen ions will make the compound only selectively available in the soil, either in the immediate environment of the root, or of fungal hyphae. This means that substance deposited initially away from roots, will be less available for degradation or leaching loss. For substances with acid pKₐs, release in the proton rich environment also allows facile diffusion across proximal membranes in the neutral form of the molecule. This results in more efficient use of the free compound.

In addition there is a need for formulations in which the release of active ingredients can be controlled, such as by the application of an inert salt buffer or solution of a variable pH that would trigger the release of the active ingredient from an insoluble formulation by encouraging ion-exchange.

Slow release formulations of fertilizers, pesticides (including herbicides, Schreiber et al., 1987) and drugs (Anand et al., 2001) are common (see reviews, Lewis and Cowsar, 1977, Patwardhan and Das, 1983), yet there are no reports of applying such formulations to crop seeds, or of using charged biopolymers as formulants for pesticides.

One such application is the protection of crops from parasites. Coating herbicide resistant seeds with a selective herbicide can prevent attachment of paracites for a limited period, however, much of the herbicide is lost through leaching allowing weeds and the parasites to attack late in the season (Kanampiu et al. 2002). There is, therefore, reason for slow release throughout the season to increase the period of protection and reduce impact on the crop itself.

There are distinct types of slow release formulations that are appropriate for molecules such as the herbicides imazapyr and pyrithiobac and other ALS-inhibitor herbicides that are slightly phytotoxic to maize, (Abayo at al., 1998), including:

(1) Covalent binding to a matrix that is either biodegraded or where the covalent linkage is slowly hydrolyzed. Anionic pesticides such as 2,4-D have been esterified to starch cellulose, and dextrans by such technologies, (Diaz et al., 2001, Jagtap, et al., 1983, and Mehltretter et al., 1974). Registration requirements are far more comprehensive with a new molecule formed when there is a covalent linkage than when there is an ionic or hydrophobic binding of parent pesticidal compound, which remains in the parent form in the formulant association and not as a new molecule as with covalent binding.

(2) Strong, non-covalent interactions with special matrices. Various slow release formulations of pharmaceutical preparations have been developed by such means specifically for pharmaceuticals, (Anand et al., 2001), but have not been used for slow release of agricultural pesticides.

The use of weak ionic interactions to bind herbicides to chemically modified montmorrilinite clays has been reported (Mishael 2002a, b), but these modified clays have too low an exchange capacity to be practical. (The exchange capacity is 50 times less than is typical for commercial biopolymers such as DEAE cellulose, DEAE dextrans, and 100 times less than those recently synthesized for water purifications such as dimethylamine cellulose (Orlando et al., 2002), meaning that 50-100 times more material would have to be used, rendering such formulations up to two orders of magnitude more bulky, severely limiting their utility.

The release of bound material from the two types of formulation described above can be further modulated by micro-encapsulation technologies that further control the rate of release (Schreiber et al., 1987, Tefft and Friend, 1993).

The use of preplant and preemergence herbicide spray treatments is being proscribed (banned) by regulators because large amounts of herbicides are being used to control a small number of weeds, often where not needed. Early in the season, it is most necessary to control weeds near the emerging crop seeds, and not between the rows. Equipment has been developed to apply herbicide as a band in the row, at the time of seeding, but farmers find the added equipment cumbersome and hard to maintain at the time of planting seed, when time is of essence. The application of herbicide to crop seed would be ideal, as early in the season all that is needed (imperatively so for high yields) is a zone clear of weeds near the emerging crop seedling. Crop seeds had rarely been used as carriers for crop-selective herbicides as the local concentration of herbicide released from the seeds causes symptoms of phytotoxicity. Seeds have not been reported as a carrier for slow release formulations of pesticides, nor for their insertion into the soil, except in the case of glyphosate, where it was proposed to form insoluble salts of glyphosate to slow its release into the seed, not into the soil, where it would rapidly be inactivated (Gressel and Joel, 2000).

We have demonstrated that by coating seeds with slow release formulations of acid herbicides bound to anion exchanging biopolymers and planting them into the soil, that it is possible to achieve longer control of parasitic weeds, with less herbicide, than by previous technologies (PCT/US03/20966). We demonstrate herein that this can be done with basic (cationic) herbicides bound to cation exchanging biopolymers as well, and for other pesticides with anionic or cationic exchangers.

### SUMMARY OF THE INVENTION

In one aspect the present invention provides for the use of one or more polymer types of mixed functionality as formulation agents in preparations of pesticidal ingredients (herbicides, fungicides, insecticides, nematicides, acaricides and rodenticides as well as other chemicals used in the wider environment).

In one embodiment, the polymers may be of biological origin. In another embodiment, the polymers are of synthetic or semi-synthetic origin. In both cases, the polymers may vary widely in length (for example, 50, 100, 200, 2000, 10000, 20000 units to greater than 50000) and may be formed of a range of repeat structures and linking arrangements including but not limited to esters, amides, ethers, glycols, alkanes, thiols, sulfones, lignins, and sugars (e.g. substituted polymers of glucose, chitin or chitosan), their derivatives and co-polymers and mixed polymers. The polymers are, by economic necessity, generally derived from bulk commodities and include but are not limited to: substituted celluloses, dextrans, polyimines, oligo- and polypeptides, styrenes, vinyls, hydroxybutyrates, starches, fructans, carbonates, paraffin derived, and lignins.

In a further embodiment, the polymeric formulation is not a single polymer but a mixture of polymers with variable functions and functionalities that bind the carried compound to different degrees.

In another embodiment, the polymer is a mixture of a synthetic and a semi-synthetic polymer or polymer of biological origin.

In another embodiment, the mixture of the pesticidal ingredients and the polymers is maintained in a solvent as a solution or suspension.

In another embodiment, the substituted biopolymers or synthetic organic polymers may positively or negatively charged or with strong hydrophobic binding groups.

In another embodiment, the polymers may have side chains that are composed of but not limited to amines, variable length carbon chains, alcohols, aromatic groups, sulfides, sulfonates, carboxy acids, halogens, chelating functions, glycols and hydrophobic binding domains.

In another embodiment, the polymers may be further grafted at their termini to introduce additional functions different from those of the repeat unit.

In one embodiment, the active compound forms hydrophobic interactions with the polymer or polymer mixture. In another, the polymer or polymer mixture has humectant properties, in another embodiment the polymer or polymer mixture is an ion exchanger.

In a preferred embodiment, the exchanger is a high capacity anion exchanger and is composed of naturally occurring functions such as primary, secondary, tertiary and quaternary amines. These include but are not limited to substituted polymers containing imines, imidazoles, dimethylamines, diethylamines, betaines and guanidines.

In another embodiment, the exchanger is a high capacity cation exchanger and includes functions such as sulfides, sulfonates, sulphoxyethyls, phosphates, carboxyalkanes, and carboxyls.

It is clear to those skilled in the art that the functionality described above can be introduced onto a variety of polymer backbones using standard reactions known in the art such as those described in U.S. Pat. No. 366,499 and materials referenced therein hereby incorporated by reference.

In another aspect, the polymers may be used as products applied in water as dispersible formulations co-administered with water. In another embodiment the same types of polymers may be incorporated into solid formulations for use in broadcast application, seed dressings or other point applications. The polymer may assist in improving the solubility or packaging of the active ingredient in the concentrated form or assist in the resuspension of the dry form of a formulation, in water.

In another embodiment, the substituted biopolymers may be soluble or remain as solid carriers, as pellets or as water-dispersible, micronized small particles and may used alone or in combination with other ingredients such as lipids or fatty acids to form microemulsions or microspheres.

In another aspect, the pesticidal ingredients of formulations may be loaded onto the polymers during or following manufacture

In another embodiment, they may be loaded by the end user.

In another embodiment, the polymers or mixtures may incorporate coding via size distribution that can be used, in addition to improved efficacy, to identify source of product and counterfeit products.

In another embodiment, the polymers can be attached to solid supports, or themselves form insoluble beads or small fibers. These beads or fibers may be derivatized as for other polymers. The beads may be selected for positive buoyancy in which case they are of potentially enhanced utility in the control of floating aquatic weeds in the case of herbicides, or of surface borne larvae or disease pathogens in the case of insecticides and fungicides, respectively. The beads/supports may also be negatively buoyant for use in paddy rice where preferential distribution of the active ingredient to the upper water or lower sediment layer may improve efficacy.

In another embodiment, the various polymer based formulations may be used as seed coats for the control of pathogens and parasites including weeds.

In another embodiment, the various polymers may be incorporated into a kit for research use to assist chemical developers in finding optimal formulations for either a new active ingredient, or a new formulation for a specific condition or use.

### DETAILED DESCRIPTION OF THE INVENTION

### Brief Description of the Figures

FIG. 1 shows a description of the invention for various polymer classes.

FIG. 2 shows an example structure for a polymeric complex with 2,4-D where B, A and D represent carbon atoms, Z and R, hydrogen atoms. 2,4-D may be replaced by a variety of compounds such as propamocarb, kasugamycin, penconazole and carbendazim

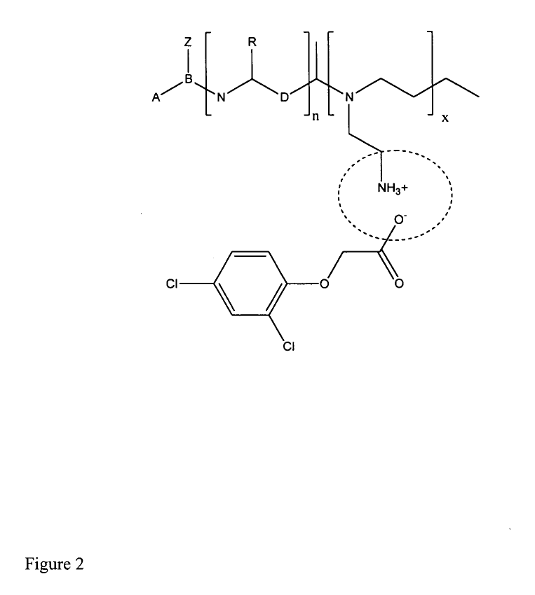

### DEFINITIONS

Pesticidal ingredient: a chemical composition that exerts a desirable effect on a pest species, said composition may, depending on its activity, be considered by those skilled in the art to be any of: herbicides, insecticides (including compounds controlling non-insect arthropods and nematodes), bacteriocides, rodenticides, and fungicides

As used herein, a “polymer” refers to a chemical composition composed of repeating units covalently bound in a linear or networked (cross-linked) array. Polymers may be homo- (one repeating unit) or hetero-polymers (composed of multiple repeat units).

“Formulations of pesticides”, as used herein, refers to mixtures of a pesticidal ingredient and other chemical compositions with the effect of permitting preparation, storage and application of the ingredient.

“Packaging”, as used herein, refers to a means of containment by which formulations are weighed, stored, sold, transported, prepared for use and applied.

As used herein, “beads” and “solid supports” refer to particles ranging in size from 1 to 10,000 microns that are water insoluble at pH 7.00 and which can directly, or following derivitisation, interact with a pesticidal ingredient.

As used herein, “rainfastness” refers to the ability of a pesticidal ingredient to be held on a leaf such that more than 20% of an amount deposited in a thin film on a leaf may be recovered from the leaf when said leaf is subject to simulated rainfall equivalent to 10 mm in an hour, said simulated rain commencing 120 minutes after application of the substance in conditions of relative humidity of 50% or less.

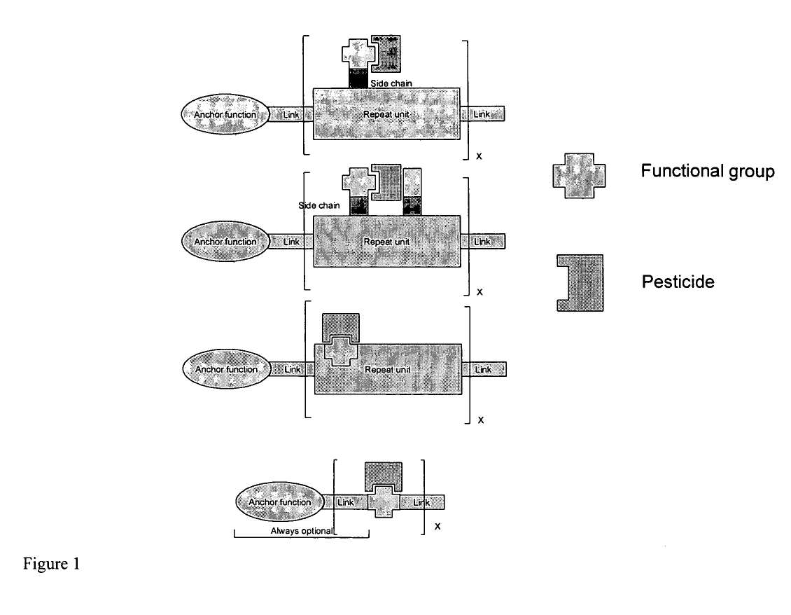

The general bio- or synthetic organic polymer formulant takes the form of the generalized structure in FIG. 1 in which a repeat unit has a functional group that forms a non-covalent interaction with a carried compound providing it with a high capacity to absorb and carry the substance.

### DESCRIPTION

Biopolymeric formulation components that are appropriately functionalized may be mixed with pesticides to form semi-stable complexes that exhibit desirable field properties including resistance to leaching through the soil, improved retention on leaf surfaces (rainfastness), selective unloading of compounds into the root environment and more convenient packaging and application. The polymers are bio-degradable (i.e. carbohydrate, amide or glycol), inexpensive, and generally regarded as safe with respect to toxicity. The polymers may be functionalized with chemical groups that exhibit ionic interactions, hydrophobic interactions, complexing (e.g. metal chelating) interactions and ligand binding interactions. The polymers may be mixed, grafted, or fused to obtain optimal release and anti-leaching properties. The polymers exert their beneficial effects through binding to both the pesticide to be delivered and interaction with the leaf, soil or organic matter to modify pesticide exposure to the environment.

The pesticides with which the invention may be useful include herbicides, insecticides (including as herein defined compounds controlling non-insect arthropods as well as nematodes), bacteriocides, rodenticides, and fungicides.

Herbicides include: in particular substances such as imidazolinone herbicides, amitrole, glyphosate, glufosinate, carbetamide Indole acetic acids; substances with a pka below 6 or above 8, or a logP (koctanol:water) above 2 or any of the following:
amide, herbicides, allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid, tebutam, anilide, herbicides, chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen, propanil, arylalanine, herbicides, benzoylprop, flamprop, flamprop-M, chloroacetanilide, herbicides, acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor, xylachlor,
sulfonanilide, herbicides, benzofluor, cloransulam, diclosulam, florasulam, flumetsulam, metosulam, perfluidone, pyrimisulfan, profluazol,
sulfonamide, herbicides, asulam, carbasulam, fenasulam, oryzalin, penoxsulam, see, also, sulfonylurea, herbicides,
antibiotic, herbicides, bilanafos,
aromatic, acid, herbicides, chloramben, dicamba, 2,3,6-TBA, tricamba, pyrimidinyloxybenzoic, acid, herbicides, bispyribac, pyriminobac, pyrimidinylthiobenzoic, acid, herbicides, pyrithiobac, phthalic, acid, herbicides, chlorthal, picolinic, acid, herbicides, aminopyralid, clopyralid, picloram, quinolinecarboxylic, acid, herbicides, quinclorac, quinmerac,
arsenical, herbicides, cacodylic, acid, CMA, DSMA, hexaflurate, MAA, MAMA, MSMA, potassium, arsenite, sodium, arsenite,
benzoylcyclohexanedione, herbicides, mesotrione, sulcotrione, benzofuranyl, alkylsulfonate, herbicides, benfuresate, ethofumesate, carbamate, herbicides, asulam, carboxazole, chlorprocarb, dichlormate, fenasulam, karbutilate, terbucarb, carbanilate, herbicides, barban, BCPC, carbasulam, carbetamide, CEPC, chlorbufam, chlorpropham, CPPC, desmedipham, phenisopham, phenmedipham, phenmedipham-ethyl, propham, swep, cyclohexene, oxime, herbicides, alloxydim, butroxydim, clethodim, cloproxydim, cycloxydim, profoxydim, sethoxydim, tepraloxydim, tralkoxydim, cyclopropylisoxazole, herbicides, isoxachlortole, isoxaflutole, dicarboximide, herbicides, benzfendizone, cinidon-ethyl, flumezin, flumiclorac, flumioxazin, flumipropyn,
dinitroaniline, herbicides, benfluralin, butralin, dinitramine, ethalfluralin, fluchloralin, isopropalin, methalpropalin, nitralin, oryzalin, pendimethalin, prodiamine, profluralin, trifluralin, dinitrophenol, herbicides, dinofenate, dinoprop, dinosam, dinoseb, dinoterb, DNOC, etinofen, medinoterb, diphenyl, ether, herbicides, ethoxyfen, nitrophenyl, ether, herbicides, acifluorfen, aclonifen, bifenox, chlomethoxyfen, chlomitrofen, etnipromid, fluorodifen, fluoroglycofen, fluoronitrofen, fomesafen, furyloxyfen, halosafen, lactofen, nitrofen, nitrofluorfen, oxyfluorfen, dithiocarbamate, herbicides, dazomet, metam, halogenated, aliphatic, herbicides, alorac, chloropon, dalapon, flupropanate, hexachloroacetone, iodomethane, methyl, bromide, monochloroacetic, acid, SMA, TCA, imidazolinone, herbicides, imazamethabenz, imazamox, imazapic, imazapyr, imazaquin, imazethapyr, inorganic, herbicides, ammonium, sulfamate, borax, calcium, chlorate, copper, sulfate, ferrous, sulfate, potassium, azide, potassium, cyanate, sodium, azide, sodium, chlorate, sulfuric, acid, nitrile, herbicides, bromobonil, bromoxynil, chloroxynil, dichlobenil, iodobonil, ioxynil, pyraclonil, organophosphorus, herbicides, amiprofos-methyl, anilofos, bensulide, bilanafos, butamifos, 2,4-DEP, DMPA, EBEP, fosamine, glufosinate, glyphosate, piperophos, phenoxy, herbicides, bromofenoxim, clomeprop, 2,4-DEB, 2,4-DEP, difenopenten, disul, erbon, etnipromid, fenteracol, trifopsime, phenoxyacetic, herbicides, 4-CPA, 2,4-D, 3,4-DA, MCPA, MCPA-thioethyl, 2,4,5-T, phenoxybutyric, herbicides, 4-CPB, 2,4-DB, 3,4-DB, MCPB, 2,4,5-TB, phenoxypropionic, herbicides, cloprop, 4-CPP, dichlorprop, dichlorprop-P, 3,4-DP, fenoprop, mecoprop, mecoprop-P, aryloxyphenoxypropionic, herbicides, chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop, phenylenediamine, herbicides, dinitramine, prodiamine, phenyl, pyrazolyl, ketone, herbicides, benzofenap, pyrazolynate, pyrazoxyfen, topramezone, pyrazolylphenyl, herbicides, fluazolate, pyraflufen, pyridazine, herbicides, credazine, pyridafol, pyridate, pyridazinone, herbicides, brompyrazon, chloridazon, dimidazon, flufenpyr, metflurazon, norflurazon, oxapyrazon, pydanon, pyridine, herbicides, aminopyralid, cliodinate, clopyralid, dithiopyr, fluroxypyr, haloxydine, picloram, picolinafen, pyriclor, thiazopyr, triclopyr, pyrimidinediamine, herbicides, iprymidam, tioclorim, quaternary, ammonium, herbicides, cyperquat, diethamquat, difenzoquat, diquat, morfamquat, paraquat, thiocarbamate, herbicides, butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate, vernolate, thiocarbonate, herbicides, dimexano, EXD, proxan, thiourea, herbicides, methiuron, triazine, herbicides, dipropetryn, triaziflam, trihydroxytriazine, chlorotriazine, herbicides, atrazine, chlorazine, cyanazine, cyprazine, eglinazine, ipazine, mesoprazine, procyazine, proglinazine, propazine, sebuthylazine, simazine, terbuthylazine, trietazine, methoxytriazine, herbicides, atraton, methometon, prometon, secbumeton, simeton, terbumeton, methylthiotriazine, herbicides, ametryn, aziprotryne, cyanatryn, desmetryn, dimethametryn, methoprotryne, prometryn, simetryn, terbutryn, triazinone, herbicides, ametridione, amibuzin, hexazinone, isomethiozin, metamitron, metribuzin, triazole, herbicides, amitrole, cafenstrole, epronaz, flupoxam, triazolone, herbicides, amicarbazone, carfentrazone, flucarbazone, propoxycarbazone, sulfentrazone, triazolopyrimidine, herbicides, cloransulam, diclosulam, florasulam, flumetsulam, metosulam, penoxsulam, uracil, herbicides, butafenacil, bromacil, flupropacil, isocil, lenacil, terbacil, urea, herbicides, benzthiazuron, cumyluron, cycluron, dichloralurea, diflufenzopyr, isonoruron, isouron, methabenzthiazuron, monisouron, noruron, phenylurea, herbicides, anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, thidiazuron, sulfonylurea, herbicides, pyrimidinylsulfonylurea, herbicides, amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron, trifloxysulfuron, triazinylsulfonylurea, herbicides, chlorsulfuron, cinosulfuron, ethametsulfuron, iodosulfuron, metsulfuron, prosulfuron, thifensulfuron, triasulfuron, tribenuron, triflusulfuron, tritosulfuron, thiadiazolylurea, herbicides, buthiuron, ethidimuron, tebuthiuron, thiazafluron, thidiazuron, unclassified, herbicides, acrolein, allyl, alcohol, azafenidin, benazolin, bentazone, benzobicyclon, buthidazole, calcium, cyanamide, cambendichlor, chlorfenac, chlorfenprop, chlorflurazole, chlorflurenol, cinmethylin, clomazone, CPMF, cresol, ortho-dichlorobenzene, dimepiperate, endothal, fluoromidine, fluridone, flurochloridone, flurtamone, fluthiacet, indanofan, methazole, methyl, isothiocyanate, nipyraclofen, OCH, oxadiargyl, oxadiazon, oxaziclomefone, pentachlorophenol, pentoxazone, phenylmercury, acetate, pinoxaden, prosulfalin, pyribenzoxim, pyriftalid, quinoclamine, rhodethanil, sulglycapin, thidiazimin, tridiphane, trimeturon, tripropindan, tritac.

Fungicides include pyridine, carbamate and benzimidazole type fungicides (respectively cyprodinil, propamocarb, and carbendazim) penconazole, validamycin, kasugamycin, butylamine; substances with a pka below 6 or above 8, or a logP (koctanol:water) above 2 or any of the following:
aliphatic nitrogen fungicides, butylamine, cymoxanil, dodicin, dodine, guazatine, iminoctadine, amide fungicides, carpropamid, chloraniformethan, cyflufenamid, diclocymet, ethaboxam, fenoxanil, flumetover, furametpyr, mandipropamid, penthiopyrad, prochloraz, quinazamid, silthiofam, triforine, acylamino acid fungicides, benalaxyl, benalaxyl-M, furalaxyl, metalaxyl, metalaxyl-M, pefurazoate, anilide fungicides, benalaxyl, benalaxyl-M, boscalid, carboxin, fenhexamid, metalaxyl, metalaxyl-M, metsulfovax, ofurace, oxadixyl, oxycarboxin, pyracarbolid, thifluzamide, tiadinil, benzanilide fungicides, benodanil, flutolanil, mebenil, mepronil, salicylanilide, tecloftalam, furanilide fungicides, fenfuram, furalaxyl, furcarbanil, methfuroxam, sulfonanilide fungicides, flusulfamide, benzamide fungicides, benzohydroxamic acid, fluopicolide, tioxymid, trichlamide, zarilamid, zoxamide, furamide fungicides, cyclafuramid, furmecyclox, phenylsulfamide fungicides, dichlofluanid, tolylfluanid, sulfonamide fungicides, cyazofamid, valinamide fungicides, benthiavalicarb, iprovalicarb, antibiotic fungicides, aureofungin, blasficidin-S, cycloheximide, griseofulvin, kasugamycin, natamycin, polyoxins, polyoxorim, streptomycin, validamycin, strobilurin fungicides, azoxystrobin, dimoxystrobin, fluoxastrobin, kresoxim-methyl, metominostrobin, orysastrobin, picoxystrobin, pyraclostrobin, trifloxystrobin, aromatic fungicides, biphenyl, chlorodinitronaphthalene, chloroneb, chlorothalonil, cresol, dicloran, hexachlorobenzene, pentachlorophenol, quintozene, sodium pentachlorophenoxide, tecnazene, benzimidazole fungicides, benomyl, carbendazim, chlorfenazole, cypendazole, debacarb, fuberidazole, mecarbinzid, rabenzazole, thiabendazole, benzimidazole precursor fungicides, furophanate, thiophanate, thiophanate-methyl, benzothiazole fungicides, bentaluron, chlobenthiazone, TCMTB, bridged diphenyl fungicides, bithionol, dichlorophen, diphenylamine, carbamate fungicides, benthiavalicarb, furophanate, iprovalicarb, propamocarb, thiophanate, thiophanate-methyl, benzimidazolylcarbamate fungicides, benomyl, carbendazim, cypendazole, debacarb, mecarbinzid, carbanilate fungicides, diethofencarb, conazole fungicides, conazole fungicides (imidazoles), climbazole, clotrimazole, imazalil, oxpoconazole, prochloraz, triflumizole, see also imidazole fungicides, conazole fungicides (triazoles), azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, see also triazole fungicides, copper fungicides, Bordeaux mixture, Burgundy mixture, Cheshunt mixture, copper acetate, copper carbonate, basic, copper hydroxide, copper naphthenate, copper oleate, copper oxychloride, copper sulfate, copper sulfate, basic, copper zinc chromate, cufraneb, cuprobam, cuprous oxide, mancopper, oxine copper, dicarboximide fungicides, famoxadone, fluoroimide, dichlorophenyl dicarboximide fungicides, chlozolinate, dichlozoline, iprodione, isovaledione, myclozolin, procymidone, vinclozolin, phthalimide fungicides, captafol, captan, ditalimfos, folpet, thiochlorfenphim, dinitrophenol fungicides, binapacryl, dinobuton, dinocap, dinocap-4,dinocap-6, dinocton, dinopenton, dinosulfon, dinoterbon, DNOC, dithiocarbamate fungicides, azithiram, carbamorph, cufraneb, cuprobam, disulfiram, ferbam, metam, nabam, tecoram, thiram, ziram, cyclic dithiocarbamate fungicides, dazomet, etem, milneb, polymeric dithiocarbamate fungicides, mancopper, mancozeb, maneb, metiram, polycarbamate, propineb, zineb, imidazole fungicides, cyazofamid, fenamidone, fenapanil, glyodin, iprodione, isovaledione, pefurazoate, triazoxide, see also conazole fungicides (imidazoles), inorganic fungicides, potassium azide, potassium thiocyanate, sodium azide, sulfur, see also copper fungicides, see also inorganic mercury fungicides, mercury fungicides, inorganic mercury fungicides, mercuric chloride, mercuric oxide, mercurous chloride, organomercury fungicides, (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate, morpholine fungicides, aldimorph, benzamorf, carbamorph, dimethomorph, dodemorph, fenpropimorph, flumorph, tridemorph, organophosphorus fungicides, ampropylfos, ditalimfos, edifenphos, fosetyl, hexylthiofos, iprobenfos, phosdiphen, pyrazophos, tolclofos-methyl, triamiphos, organotin fungicides, decafentin, fentin, tributyltin oxide, oxathiin fungicides, carboxin, oxycarboxin, oxazole fungicides, chlozolinate, dichlozoline, drazoxolon, famoxadone, hymexazol, metazoxolon, myclozolin, okadixyl, vinclozolin, polysulfide fungicides, barium polysulfide, calcium polysulfide, potassium polysulfide, sodium polysulfide, pyrazole fungicides, furametpyr, penthiopyrad, pyridine fungicides, boscalid, buthiobate, dipyrithione, fluazinam, fluopicolide, pyridinitril, pyrifenox, pyroxychlor, pyroxyfur, pyrimidine fungicides, bupirimate, cyprodinil, diflumetorim, dimethirimol, ethirimol, fenarimol, ferimzone, mepanipyrim, nuarimol, pyrimethanil, triarimol, pyrrole fungicides, fenpiclonil, fludioxonil, fluoroimide, quinoline fungicides, ethoxyquin, halacrinate, 8-hydroxyquinoline sulfate, quinacetol, quinoxyfen, quinone fungicides, benquinox, chloranil, dichlone, dithianon, quinoxaline fungicides, chinomethionat, chlorquinox, thioquinox, thiazole fungicides, ethaboxam, etridiazole, metsulfovax, octhilinone, thiabendazole, thiadifluor, thifluzamide, thiocarbamate fungicides, methasulfocarb, prothiocarb, thiophene fungicides, ethaboxam, silthiofam, triazine fungicides, anilazine, triazole fungicides, bitertanol, fluotrimazole, triazbutil, see also conazole fungicides (triazoles), urea fungicides, bentaluron, pencycuron, quinazamid, unclassified fungicides, acibenzolar, acypetacs, allyl alcohol, benzalkonium chloride, benzamacril, bethoxazin, carvone, chloropicrin, DBCP, dehydroacetic acid, diclomezine, diethyl pyrocarbonate, fenaminosulf, fenitropan, fenpropidin, formaldehyde, furfural, hexachlorobutadiene, iodomethane, isoprothiolane, methyl bromide, methyl isothiocyanate, metrafenone, nitrostyrene, nitrothal-isopropyl, OCH, 2-phenylphenol, phthalide, piperalin, probenazole, proquinazid, pyroquilon, sodium orthophenylphenoxide, spiroxamine, sultropen, thicyofen, tricyclazole, zinc naphthenate,

Insecticides include thiocyclam, nicotine, CGA50439, cartap; substances with a pka below 6 or above 8, or a logP (koctanol:water) above 2 or any of the following:
antibiotic insecticides, allosamidin, thuringiensin, macrocyclic lactone insecticides, spinosad, avermectin insecticides, abamectin, doramectin, emamectin, eprinomectin, ivermectin, selamectin, milbemycin insecticides, lepimectin, milbemectin, milbemycin oxime, moxidectin, arsenical insecticides, calcium arsenate, copper acetoarsenite, copper arsenate, lead arsenate, potassium arsenite, sodium arsenite, botanical insecticides, anabasine, azadirachtin, d-limonene, nicotine, pyrethrins, cinerins, cinerin I, cinerin II, jasmolin I, jasmolin II, pyrethrin I, pyrethrin II, quassia, rotenone, ryania, sabadilla, carbamate insecticides, bendiocarb, carbaryl, benzofuranyl methylcarbamate insecticides, benfuracarb, carbofuran, carbosulfan, decarbofuran, furathiocarb, dimethylcarbamate insecticides, dimetan, dimetilan, hyquincarb, pirimicarb, oxime carbamate insecticides, alanycarb, aldicarb, aldoxycarb, butocarboxim, butoxycarboxim, methomyl, nitrilacarb, oxamyl, tazimcarb, thiocarboxime, thiodicarb, thiofanox, phenyl methylcarbamate insecticides, allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC, xylylcarb, dinitrophenol insecticides, dinex, dinoprop, dinosam, DNOC, fluorine insecticides, barium hexafluorosilicate, cryolite, sodium fluoride, sodium hexafluorosilicate, sulfluramid, formamidine insecticides, amitraz, chlordimeform, formetanate, formparanate, fumigant insecticides, acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride, tetrachloroethane, inorganic insecticides, borax, calcium polysulfide, copper oleate, mercurous chloride, potassium thiocyanate, sodium thiocyanate, see also arsenical insecticides, see also fluorine insecticides, insect growth regulators, chitin synthesis inhibitors, bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron, triflumuron, juvenile hormone mimics, epofenonane, fenoxycarb, hydroprene, kinoprene, methoprene, pyriproxyfen, triprene, juvenile hormones, juvenile hormone I, juvenile hormone II, juvenile hormone III, moulting hormone agonists, chromafenozide, halofenozide, methoxyfenozide, tebufenozide, moulting hormones, α-ecdysone, ecdysterone, moulting inhibitors, diofenolan, precocenes, precocene I, precocene II, precocene III, unclassified insect growth regulators, dicyclanil, nereistoxin analogue insecticides, bensultap, cartap, thiocyclam, thiosultap, nicotinoid insecticides, flonicamid, nitroguanidine insecticides, clothianidin, dinotefuran, imidacloprid, thiamethoxam, nitromethylene insecticides, nitenpyram, nithiazine, pyridylmethylamine insecticides, acetamiprid, imidacloprid, nitenpyram, thiacloprid, organochlorine insecticides, bromo-DDT, camphechlor, DDT, pp′-DDT, ethyl-DDD, HCH, gamma-HCH, lindane, methoxychlor, pentachlorophenol, TDE, cyclodiene insecticides, aldrin, bromocyclen, chlorbicyclen, chlordane, chlordecone, dieldrin, dilor, endosulfan, endrin, HEOD, heptachlor, HHDN, isobenzan, isodrin, kelevan, mirex, organophosphorus insecticides, organophosphate insecticides, bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP, tetrachlorvinphos, organothiophosphate insecticides, dioxabenzofos, fosmethilan, phenthoate, aliphatic organothiophosphate insecticides, acethion, amiton, cadusafos, chlorethoxyfos, chlormephos, demephion, demephion-O, demephion-S, demeton, demeton-O, demeton-S, demeton-methyl, demeton-O-methyl, demeton-5-methyl, demeton-5-methylsulphon, disulfoton, ethion, ethoprophos, IPSP, isothioate, malathion, methacrifos, oxydemeton-methyl, oxydeprofos, oxydisulfoton, phorate, sulfotep, terbufos, thiometon, aliphatic amide organothiophosphate insecticides, amidithion, cyanthoate, dimethoate, ethoate-methyl, formothion, mecarbam, omethoate, prothoate, sophamide, vamidothion, oxime organothiophosphate insecticides, chlorphoxim, phoxim, phoxim-methyl, heterocyclic organothiophosphate insecticides, azamethiphos, coumaphos, coumithoate, dioxathion, endothion, menazon, morphothion, phosalone, pyraclofos, pyridaphenthion, quinothion, benzothiopyran organothiophosphate insecticides, dithicrofos, thicrofos, benzotriazine organothiophosphate insecticides, azinphos-ethyl, azinphos-methyl, isoindole organothiophosphate insecticides, dialifos, phosmet, isoxazole organothiophosphate insecticides, isoxathion, zolaprofos, pyrazolopyrimidine organothiophosphate insecticides, chlorprazophos, pyrazophos, pyridine organothiophosphate insecticides, chlorpyrifos, chlorpyrifos-methyl, pyrimidine organothiophosphate insecticides, butathiofos, diazinon, etrimfos, lirimfos, pirimiphos-ethyl, pirimiphos-methyl, primidophos, pyrimitate, tebupirimfos, quinoxaline organothiophosphate insecticides, quinalphos, quinalphos-methyl, thiadiazole organothiophosphate insecticides, athidathion, lythidathion, methidathion, prothidathion, triazole organothiophosphate insecticides, isazofos, triazophos, phenyl organothiophosphate insecticides, azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, trifenofos, phosphonate insecticides, butonate, trichlorfon, phosphonothioate insecticides, mecarphon, phenyl ethylphosphonothioate insecticides, fonofos, trichloronat, phenyl phenylphosphonothioate insecticides, cyanofenphos, EPN, leptophos, phosphoramidate insecticides, crufomate, fenamiphos, fosthietan, mephosfolan, phosfolan, pirimetaphos, phosphoramidothioate insecticides, acephate, isocarbophos, isofenphos, methamidophos, propetamphos, phosphorodiamide insecticides, dimefox, mazidox, mipafox, schradan, oxadiazine insecticides, indoxacarb, phthalimide insecticides, dialifos, phosmet, tetramethrin, pyrazole insecticides, acetoprole, ethiprole, fipronil, pyrafluprole, pyriprole, tebufenpyrad, tolfenpyrad, vaniliprole, pyrethroid insecticides, pyrethroid ester insecticides, acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, pyrethroid ether insecticides, etofenprox, flufenprox, halfenprox, protrifenbute, silafluofen, pyrimidinamine insecticides, flufenerim, pyrimidifen, pyrrole insecticides, chlorfenapyr, tetronic acid insecticides, spiromesifen, thiourea insecticides, diafenthiuron, urea insecticides, flucofuron, sulcofuron, see also chitin synthesis inhibitors, unclassified insecticides, closantel, crotamiton, EXD, fenazaflor, fenoxacrim, flubendiamide, hydramethylnon, isoprothiolane, malonoben, metaflumizone, metoxadiazone, nifluridide, pyridaben, pyridalyl, rafoxanide, triarathene, triazamate,
   Polymers

Polymers useful for the formulation and complexation of pesticides can be considered in two steps: the main polymer backbone and the side chains derivatised to them. Polymers described in this invention include polymers of biological origin and polymers of synthetic or semi-synthetic origin.

Polymers of biological origin include sugar and non-sugar polymers. Sugar based polymers include but are not limited to cellulose, chitin, chitosan, dextran, starch, glycogen, alginate agar, agarose, amylopectin, amylase, glucosaminoglycans. Non-sugar polymers of natural origin include but are not limited to: lignin, polyhydroxybutanoate, silk, peptides such as gelatin or polylysine and latex/rubber.

Synthetic and semi-synthetic polymers useful in this invention may be organic or inorganic. Inorganic polymers include silicones.

Organic polymers include but are not limited to polyamides, polyimines, polyamines, glycols, vinyls, styrenes examples of which may include: acrylonitrile butadiene styrene (ABS), polyamide (PA), polybutadiene, poly(butylene terephthalate) (PBT), polycarbonate, poly(ether sulphone) (PES, PES/PEES), poly(ether ether ketone)s (PEEK, PES/PEEK), polyethylene (PE), poly(ethylene glycol) (PEG), poly(ethylene terephthalate) (PET), polyimide, polypropylene (PP), polystyrene (PS), styrene acrylonitrile (SAN), poly(trimethylene terephthalate) (PTT), polyurethane (PU), polyvinylchloride (PVC), polyvinyldifluorine (PVDF), poly(vinyl pyrrolidone) (PVP), Hydroxy-terminated polybutadiene, Polymethyl methacrylate, Polypyrrole, Polyurea, Polyurethane, Polyvinyl acetate, Rayon, Nitrocellulose, Nylon, PVDF, Phenol formaldehyde resin, Polyacrylamide, Polyacrylonitrile, Polyaniline, Polydiacetylenes, Polyester as well as derivatives thereof.

Semi-synthetic polymers include substances such as DEAE cellulose, nitrocellulose, carboxymethyl cellulose, quaternary amine substituted cellulose, and phosponic and sulfonic acid derivatised celluloses.

Where the polymer itself does not interact strongly with a pesticide (i.e. raw cellulose or PEG), it may be derivatised with functions that do make interaction possible. These derivitisation processes are widely known in the art and are cited or described herein.

Formulations of pesticides are made by forming a slurry (or solution) of the pesticide and polymer in compatible (miscible) solvents and then mixing the two followed by drying or concentration if the final product is not dry.

The polymers are prepared from common and inexpensive large scale materials including: cellulose, dextran, ethylene glycol, polyethyleneimine, vinyls, acetates, amides and so on. To increase interaction with the pesticides, the polymers are derivatised to form functional groups that interact with the selected pesticides. The interactions may be hydrophobic, ionic or chelation based. Derivitisations include the addition of acid groups, basic groups and alkyl chains. Polymer backbones may be mixed either prior to derivitisation, or afterwards. Derivitisation may be also used to crosslink polymers to form gels or more stable particles.

Formulations of pesticides are made by forming a slurry (or solution) of the pesticide and polymer in compatible (miscible) solvents and then mixing the two followed by drying. The details for particular polymers and pesticides are described in the following examples.

### EXAMPLES

### Example 1

### Synthesizing Solid Slow Release Cellulose-Based Formulations of Water Soluble, Negatively Charged Fungicides and Insecticides to Solid Anion Exchange Resins

One hundred grams of dried cellulose powder was reacted with 1 liter epichlorohydrin in 1.2 l of dimethylformamide at 100° C. for 1 h to etherify the cellulose. 400 ml of pyridine was added to the solution and stirring maintained at 100° C. until slight browning of the cellulose is observed. Amine groups were then introduced by adding 1 l of 50% dimethylamine solution. The mixture was stirred for 3 h at 100° C. The reaction product was washed with 20 l of HCl (0.1 M), 20 l of NaOH (0.1 M), and 20 l of 50% aqueous ethanol at 40° C. Yield of the dimethylamine cellulose anion exchanger (DMCAE) was greater than 110% with an exchange capacity of about 3.5 meq/g.

In this reaction scheme, dimethylamine may be substituted for any of the following: methylamine (33% in ethanol), ethylamine (70% in water), diethylamine (99%), triethylamine (99%), ethanolamine, diethanoloamine, triethanolamine (all 99%), ethylene diamine (exothermic reaction), methylaminoethanol, N ethylisopropylamine, diisopropylamine, ammonia and similar amines available in large scale.

A 20 g dry weight equivalents of DMCAE was mixed each with of the pyridine, carbamate and benzimidazole type fungicides, respectively cyprodinil, propamocarb, and carbendazim, as well as a similar aliquot was reacted with equi-meq amounts of insecticide thiocyclam, all as a slurry in 50 ml water until the small amount of measurable free pesticide was constant. The samples of each were dried, and half of each sample was kept for solid dispersal on soil surface either as a fine powder or as micropellets, or as an application to seeds, and the other half was micronized in a ball mill, for formulation in a non-ionic detergent and water for use as a water dispersible spray for foliar or soil application, or application to seeds. Soil application includes broadcast and row applications. Broadcast is the spreading of a solid formulation using any of a range of techniques to distribute discreet pellets evenly over the soil surface (as is employed with fertilizers and pelletized pesticides). Row applications include any of a range of techniques to apply pesticides locally in a seeding row either at the surface after seeding or via application in the seed furrow itself (often called band application).

### Example 2

### Synthesizing Soluble Slow Release Cellulose-Based Formulations of Water Soluble, Negatively Charged Fungicides and Insecticides to Water-Soluble Anion Exchange Resin

One hundred grams of dried cellulose powder was reacted with 400 ml of pyridine with continuous stirring for 1 h at 100° C. to open and solubilize the cellulose. Amine groups were then introduced by adding 1 l of 50% dimethylamine solution. The mixture was stirred for 3 h at 100° C. The reaction product was washed with 20 l of NaOH (0.1 M), 20 l of HCl (0.1 M) and 20 l of 50% aqueous ethanol at 40° C. Yield of the dimethylamine cellulose anion exchanger (DMCAE) was about 160% with an exchange capacity of about 3.5 meq/g. A 20 g dry weight equivalents of DMCAE was reacted each with equi-meq amounts of the pyridine, carbamate and benzimidazole type fungicides, respectively cyprodinil, propamocarb, and carbendazim, as well as a similar aliquot was reacted with equi-meq amounts of insecticide thiocyclam, all as a slurry in 50 ml water until the small amount of measurable free pesticide was constant. The samples of each were dried, and half of each sample was kept for solid dispersal on soil surface or to crop seeds, either as a fine powder or as micropellets, either often with sticking agents, and the other half was micronized in a ball mill, for formulation in a non-ionic detergent and water for use as a water dispersible spray.

### Example 3

### Synthesizing Slow Release Formulations of Water Soluble, Negatively Charged Pesticides to Liquid Anion Exchange Resins

20 g dry DEAE Dextran C1 form (Batch 99456 mfg 26-3-2003 pK Chemicals A/S, Copenhagen MW 500,000 viscosity 0.5) were dissolved in 50 ml 0.5N NaOH (1 g/50 ml) and stirred for 30 minutes and dialyzed overnight against water with one change of water. 10 g solid imazapyr acid added in a beaker with sufficient water to allow stirring until fully dissolved. pH measured at 4.5, and left. Dried in vacuum oven at 80 C. Similarly, equi meq amounts of the pyridine, carbamate and benzimidazole type fungicides, respectively cyprodinil, propamocarb, and carbendazim, are reacted with equi-meq amounts of insecticide thiocyclam, all are bound to this matrix in a similar manner.

### Example 4

Synthesizing slow release formulations of water soluble, negatively charged pesticides with strong phosphate group to liquid anion exchange resins—glyphosate. The methods and details of U.S. Pat. No. 6,096,686, detailing seed dressing compositions of glyphosate, are incorporated herein by reference. In addition, concentration of herbicide solutions and other non-novel details are incorporated into this application from the articles by Kanampiu et al., 2001, 2002, 2003.

20 g dry DEAE Dextran C1 form (Batch 99456 mfg 26-3-2003 pK Chemicals A/S, Copenhagen MW 500,000 viscosity 0.5, 2 meq/g) dissolved with 7.15 g glyphosate (MW 169, thus 20 g will complex 6.79 g glyphosate acid=7.15.g 95% material, with heating on magnetic stirrer. The pH was elevated to 4.5 and the glyphosate dissolved and bound.

### Example 5

Synthesizing slow release formulations of water slightly soluble, negatively charged pesticides to anion exchange resins. A slurry of solid pesticide, solid or soluble anion exchanger and 5% acetone, dimethyl sulfoxide or other water miscible organic solvents that partially dissolved the pesticide in water (to assist in developing a strong partitioning gradient to immediately replace the tiny amount of water-soluble pesticide that binds to the exchange resin

### Example 6

Synthesizing slow release formulations of water soluble, positively charged herbicides, fungicides and insecticides to solid biopolymeric cation exchange resins. Microgranular (Whatman CM 52-2.5 meq/g small ion exchange capacity) and fibrous (Whatman CM 23 0.6 meq/g small ion exchange capacity) solid, carboxymethyl-substituted cross-linked cellulose as well as Whatman P 11 orthophosphate-substituted fibrous cellulose (4 meq/g small ion exchange capacity) in the H⁺ form are mixed, in aqueous slurry with equal meq amounts of herbicides such as amitrole and glyphosate, insecticides such as nicotine, CGA50439, and fungicides such as validamycin, and kasugamycin that have pK values above 8 and are positively charged until complexation is completed, and dried. The solid cation exchanger pesticide complexes are applied as a solid to the soil, or are micronized in a ball mill and applied as a water dispersible spray. Sparingly soluble pesticides such as the herbicide carbetamide are bound using the technology outlined in Example 5.

### Example 7

Synthesizing slow release, humectant, sticker, penetrant, anti-drift formulations of water soluble, positively charged pesticides to liquid cation exchange resins. Amitrole (pKₐ=9.8), and the non-selective herbicides with more than one pKₐ and bearing a strong phosphate group such as glyphosate (pKₐ=10.3) and glufosinate (pKₐ=9.8) are bound to such cation exchangers including soluble carboxymethyl cellulose and carboxymethyl dextrans. The bound herbicides are sprayed on unwanted vegetation, in the presence or absence of a glyphosate or glufosinate resistant crops, respectively, in a minimal amount of water—preferably less than 50 liters per hectare, but under 100 liters, from a ground based or aerial spray rig. The rheological properties prevent the formation of ultra small; aerosol particles that drift off target, a major problem with aerial (especially) as well as ground based spraying, while the stickiness of the polymer prevents large particles from falling off the target weed leaves. The hygroscopic properties of the polymer typically absorb sufficient water to provide an absorption film that allows enhanced uptake of the herbicide into target weed for a longer period than obtainable without the polymer. Similar preparations with the same properties can be made with other cationic pesticides for foliar applied, drift reduced, better stickiness and enhanced adsorption.

Alternative polymers are used in this application according to cost and efficacy. These include sulfonated polymers such as Narlex D.-72, Versa TL-3 and TL-4 amongst others (supplied by see www.alcochemical.com). In general, the strength of cationic exchange polymers declines in the following order: synthetic sulfonated polymers, synthetic carboxylated polymers, polyacrylate and carboxymethylcellulose types.

### Example 8

Synthesizing slow release formulations of water almost-insoluble, positively charged pesticides to solid or liquid cation exchange resins. A slurry of solid pesticide, solid cation exchanger and 5% acetone, dimethyl sulfoxide or other water miscible organic solvents that partially dissolved the pesticide in water (to assist in developing a strong partitioning gradient to immediately replace the tiny amount of water-soluble pesticide that binds to the exchanger.

### Example 9

### Synthesizing a Slow Release Formulation Using Hydrophobic Interaction

A suitable pesticide, either in the form of free base or free acid is dissolved in liquefied paraffin or similar hydrocarbon to a final concentration of up to 10% W/W. The mixture is heated to above ambient temperature and applied to seeds or directly to the seed row where it solidifies and forms a reserve of compound in proximity to the crop plant. Alternatively, it applied to cellulose powder or to lignocellulosic agricultural wastes as a carrier, milled to an appropriate mesh size and applied to the crop seeds or soil, either as a fine powder or as micropellets.

### Example 10

### Synthesizing Multi-Purpose Slow Release, Humectant, Sticker, Penetrant, Anti Drift Spray Formulations of Water Soluble, Negatively Charged Pesticides to Liquid Anion Exchange Resins—Example Glyphosate with Polylysine and/or DEAE Dextran, Separately and in Mixture

Glyphosate is bound to an anionically modified dextran (e.g. DEAE glucan, as in example 3, di-methyl anion exchanger glucan, made in a chemical reaction similar to example 1) or polylysine, and sprayed on unwanted vegetation, in the presence or absence of a glyphosate resistant crop, in a minimal amount of water—preferably less than 50 liters per hectare, but under 100 liters, from a ground based or aerial spray rig. The rheological properties prevent the formation of ultra small; aerosol particles that drift off target, a major problem with aerial (especially) as well as ground based spraying, while the stickiness of the polymer prevents large particles from falling off the target weed leaves. The hygroscopic properties of the polymer typically absorb sufficient water to provide an absorption film that allows enhanced uptake of the herbicide into target weed for a longer period than obtainable without the polymer. Similar preparations with the same properties can be made with other cationic pesticides for foliar applied, drift reduced, better stickiness and enhanced adsorption.

### Example 13

### Preparing Water Dispersible Formulations of Solid Formulations Appropriate for Spraying

a. The herbicide imazapyr bound to anion exchangers

One formulation has the imazapyr more tightly bound [Dowex 2] than the other [DEAE Cellulose]. 20 mg imazapyr per 100 mg powder).

[4 g Dowex 2 (capacity 1 meq/g) suspended in large excess 1 N NaOH 30 min., washed into column and eluted with water overnight, put in mortar and pestle with excess water; likewise 4 g Whatman DE52 (capacity 1 meq/g) put dry in mortar and pestle. In each case 1 g imazapyr acid added, in latter case first ground dry, and then with excess water. Slurry sporadically ground in both cases over an hour. Mortars covered with Miracloth and put in vacuum oven at 60 degrees overnight. The material is then micronized in a ball mill, and prepared for spraying by adding a non-ionic detergent for dispersal.

b. As an example for negatively charged fungicides, propamocarb (pK 4.9), kasugamycin (pKs 3.2, 7.7, 11) and penconazole (pK 1.5) and carbendazim are bound to anion exchangers as in examples 1-3. Carbendazim and penconazole are sparingly soluble, so the techniques outlined in Example 5 apply, and the suspension is applied to crops.

c. As an example for negatively charged insecticides, cartap, thiocyclam (pKa 3.9) are bound to anion exchangers as in examples 1-3

d. As an example for another positively charged herbicide, carbetamide is bound to cation exchangers as in example 6, and this slightly soluble herbicide is rendered miscible with the system by using an organic solvent such as acetone, as outlined in example 8.

e. As examples for positively charged fungicides, validamycin (pk8), butylamine, and kasugamycin are bound to cation exchangers as in example 6.

f. As examples for positively charged insecticides, nicotine (pK 10.9), and the acaracide CGA-50439 are bound to cation exchangers as in example 6,

g. Synthesis and use of a slow release plant growth regulator. Indole acetic acid (pK=4.7) is bound to slow release anion exchangers, as per Examples 1-3, and used as a slow release growth regulator, e.g. to stimulate rooting on cuttings, where a continuous supply of a low concentration of the plant hormone is imperative. Indole acetic acid may be replaced with any of the phenoxy acetic acid mimics (e.g. 2,4-D) for this purpose. The free acids from this compound class may be bound to anion exchange resins (typically amines) as described in examples 1-3, essentially via conversion to the free acid and salt formation with the exchanger.

### Example 14

### Demonstration that Slow Release Formulations Suppress Leaching

Lysimeter experiments of pesticides in solid, liquid and no formulations are performed with measurements of pesticide in leachate, and appropriate bioassay of soil samples. Pesticide is applied as a normal spray suspension with dispersants/surfactants using an application rate within 50-250% of the normal in crop or target application rate. Rainfall is simulated using a “rainulator” device when available, or applied as a fine mist or drop to avoid unusual soil disturbance or run-off. Leachate is collected and sub sampled daily. Samples (1-5 mL) are acidified (for acidic compounds applied) to the relevant pKa of the analyte. The sample is then applied to a solid phase extraction column (e.g. C18-“Sep Pak™, Waters, Inc.) according to methods known in the art. Sample retained on the column is eluted using a small volume (ca. 1-2 mL) of volatile organic solvent (acetonitrile, ethylacetate), which is then concentrated by evaporation. Analysis is made by any of a variety of appropriate methods, the most typical being High Performance Liquid Chromatography (HPLC) with detection via a coupled mass spectrometer.

### Example 15

Demonstrations that soluble slow release formulations confer rainfastness and the ability for more rapid uptake into leaves. For the purposes of illustrating this concept, we will use formulations of acidic compounds such as glyphosate or 2,4-D. Preparations of these compounds made essentially as outlined in examples 1-7 are micronised in a high-speed ball mill prior to suspension in water. Alternatively 20 g dry DEAE Dextran C1 form (as noted above) or 10 mL of polyethyleneimine 50% V/V (PEI, normally diluted with at least 10 mL water) are mixed with 7.15 g glyphosate free acid MW 169, thus 20 g of DEAE Dextran will complex 6.79 g glyphosate acid=7.15 g 95% material) or an exchange equivalent amount of 2,4-D free acid with heating on magnetic stirrer.

The pH is monitored and adjusted if it falls below 4.5 in order to ionize glyphosate or 5.5 for 2,4-D. This ensures that there is sufficient ionisable material with which to complex the compounds. Once complexed, the material is diluted to between 1 and 10% W/V and administered to leaves either as hand pipetted droplets, or via an experimental spray rig (typically two overlapping fan sprays). Leaves used may be from any target plant, however, those of spinach plants (6 weeks old) are typical. Once applied, the drops are allowed to dry for 6 hours. Leaves are then harvested and rinsed with a series of 2 mL water washing solutions (typically 3-4) after which they are rinsed in 10, 20 and 30% acetone, 2 mL each. Washes are collected separately in scintillation vials, shelled with liquid nitrogen and freeze dried overnight. Samples are recovered in 500 μL of 10% MeCN and 5 μL is used for analysis of the solution via LCMS as noted above. A low overall recovery of compound in the water washes relative to that in acetone washes is indicative of rain fastness.

### Example 16

### Demonstrations that Carboxymethyl Cellulose, Glucan, Polyethylene Glycol, Dextran, Pyridine Solubilized (Non-Crosslinked) Cellulose Based Pesticide Formulations Give Rise to Sprays with Altered Droplet Size Distribution

Spray formulations of pesticides in the above slow release formulations and without the formulations are sprayed with a colored dye in a standard nozzle in a track sprayer over microscope slides. Immediately after spray pass with each, the slide is placed in a microscope under low magnification and the particle dispersal photographed. Droplet size distributions are then calculated from the resultant pictures.

### Example 17

Demonstrations that carboxymethyl cellulose, glucan, polyethylene glycol PEG, dextran, pyridine solubilized (non-crosslinked) cellulose based pesticide formulations are stickier than the material without formulant. Droplets (0.5, 1, 2.5, 5, 10, 20 μl) of formulations of pesticides in the above slow release formulations and without the formulations are placed on a horizontal leaf surface and the leaf is then tilted first 45 degrees, and runoff scored, and then at 90 degrees.

### Example 18

### Demonstration of Superiority of Solid Slow Release Formulations to Conventional Formulations—Field Efficacy of Soil Applications

Herbicides. Compounds formulated with and without slow-release formulations are sprayed onto disturbed or bare soil surfaces in field plots. Rates for each formulation are calculated for molar equivalence per given area and vary from one tenth the recommended field rate to two-fold the recommended range. Emergence of weeds in sprayed areas and relative crop productivity are measured to determine relative efficacy of the two formulations.

Insecticides. In areas of known soil infestation, compounds formulated as above may be applied to seed coats or supplied within the drill tine. Season long performance of the crop plant and density indicators for larvae are the primary means of identifying superior formulations.

### Example 19

### Demonstration of Superiority of Micronized/Sprayed Solid Slow Release Formulations to Conventional Formulations—Field Efficacy of Soil Applications

Materials are prepared according to examples 1-7 and micronized as in example 13. The materials are applied to a target crop in a manner similar to that used in example 18 using a standard randomized agronomically valid plot design. During the season, pest density is monitored and yield at seasons end is compared for the various treatments. Where it is clear from mid-season sampling that pest control ceased before influencing harvest, change in pest density is the primary metric.

### Example 20

### Demonstration of Superiority of Liquid Slow Release Formulations to Conventional Formulations—Field Efficacy of Soil Applications

Materials are prepared according to examples 5 or 8 and micronized or further processed as in example 13. The materials are applied to a target crop prior to planting or in the drill row in a manner similar to that used in example 18 using a standard randomized agronomically valid plot design. During the season, pest density is monitored and yield at seasons end is compared for the various treatments. Where it is clear from mid-season sampling that pest control ceased before influencing harvest, change in pest density is the primary metric.

### Example 21

### Demonstration of Superiority of Solid Slow Release Formulations to Conventional Formulations—Field Efficacy of Seed Coated Anion Exchanger Formulated Fungicides and Insecticides, and Cation Exchanger Formulated Herbicides, Fungicides and Insecticides

Materials are prepared according to examples 1 to 8 and micronized or further processed as in example 13. The materials are applied to a target crop prior to planting or in the drill row in a manner similar to that used in example 18 using a standard randomized agronomically valid plot design. During the season, pest density is monitored and yield at seasons end is compared for the various treatments. Where it is clear from mid-season sampling that pest control ceased before influencing harvest, change in pest density is the primary metric.

### Example 22

### Demonstration of Superiority of Micronized Solid Slow Release Formulations to Conventional Formulations—Field Efficacy

Materials are prepared according to examples 1-7 and micronized as in example 13. The materials are applied as broadcast pellets or in a standard spray system in a standard randomized agronomically valid plot design. During the season, target pest density is monitored and yield at seasons end is compared for the various treatments. Where it is clear from mid-season sampling that pest control ceased before influencing harvest, change in pest density is the primary metric.

### Example 23

### Demonstration of Superiority of Liquid Slow Release Formulations to Conventional Formulations—Field Efficacy of Seed Coated Material

Materials are prepared according to examples 34. The materials are applied to a target crop in a manner similar to that used in example 18 using a standard randomized agronomically valid plot design and compared with standard formulations. During the season, pest density is monitored and yield at seasons end is compared for the various treatments. Where it is clear from mid-season sampling that pest control ceased before influencing harvest, change in pest density is the primary metric.

### Example 24

### Demonstration of Superiority of Liquid Slow Release Formulations to Conventional Formulations—Field Efficacy of Foliar Applications

Materials are prepared according to examples 1-7 and micronized as in example 13. The materials are applied to a target crop/pest after emergence in a manner similar to that used in example 18 using a standard randomized agronomically valid plot design. During the season, pest density is monitored and yield at seasons end is compared for the various treatments. Where it is clear from mid-season sampling that pest control ceased before influencing harvest, change in pest density is the primary metric.

### Example 25

### Demonstration of Superiority of Liquid Multifunctional Slow Release Formulations to Conventional Formulations—Field Efficacy of Foliar Applications

Materials are prepared according to examples 1-7 and micronized as in example 13. The materials are applied to a target crop in a manner similar to that used in example 18 using a standard randomized agronomically valid plot design. Immediately after application and 1, 4, 8, 24, 48, and 72 h after application, leaves are sample and rinsed in 25% acetone to recover non absorbed pesticide. Where plots are subject to rainfall within 72 h of application, rainfall is monitored and leaves recovered for analysis of residual compound. During the season, pest density is monitored and yield at seasons end is compared for the various treatments. Where it is clear from mid-season sampling that pest control ceased before influencing harvest, change in pest density is the primary metric.

### Example 26

### Pesticide Formulations Based on Chitosan

Chitosan is a by product of the processing of chitin and has one primary amine per sugar monomer. Chitosan may act as an exchanger through complexation of anions via the amine. Chitosan may also be further modified to increase the number of charged groups by reaction with various polymers to form covalent links to a polymer network.

20 g of finely ground dried chitosan is taken up in 100 mL of 28% NaOH and the mixture held at 4 C for 2 hours. To this mixture, 50 mL of epichlorohydrin is added and the mixture then placed in a flask with reflux closure. The mixture is heated by placement on a 90 C water bath and stirred by a mechanical stirring system. Released Cl gas is vented via a fume hood. Exothermic reaction between epichlorohydrin and the polymer will result in evaporation of epichlorohydrin and care must be taken to limit exposure of operators to this gas. After 2 h, the mixture is washed in 50% ethanol and the solids recovered. The drained mixture is further reacted with amine containing functions. In this example, the solids are suspended in a 25 g polyethyleneimine (as 50% solution in water) and 100 mL MeCN (50% in water). The mixture is heated to 90 C and allowed to react for 4 h. Thereafter, the solids are washed in 50% ethanol, then 0.1 M NaOH followed by extensive washes in deionised water until the supernatant is at pH 7.00. A similar derivatisation can be performed with agar in place of chitosan. Agar is first dissolved in hot water (10% or greater solution) prior to addition of epichlorohydrin.

### Example 27

### Pesticide Formulations Based on Polyethyleneimine (PEI) and Related Amine Containing Polymers

To a reaction flask the following are added: 50 g polyethyleneimine (PEI) (as 50% solution in water) and 500 mL MeCN (50% in water) containing 0.05 M NaOH. The mixture is stirred until the polymer is dissolved and heated to 80 C on a hot plate. 5 ml of Epichlorohydrin is added dropwise and the mixture stirred until a uniform distribution of epichlorohydrin is achieved. The reaction is allowed to proceed without stirring for 4 h or overnight. The mixture forms a clear gel and this may be washed with 50% ethanol/deionised water to remove any unreacted epichlorhydrin. The gel may used in that format, or swollen with 100% ethanol to a final ethanol concentration of 50% prior to mixing with pesticides.

The gel may be modified by adding additional polymers such as polyvinylpyrrolidone (e.g. 10% W/V), polyethyleneglycol, dextrans, polylysine, polyamides, C10-C24 alkane derivatives such as alcohols.

Polycationic polymers such as PEI may be modified in other ways by modifying the proportion of epichlorohydrin. As the proportion increases, the reactive sites on the polymer are saturated and the degree of cross-linking is reduced. Mixing 25 g polyethyleneimine (PEI) (as 50% solution in water) and 250 mL MeCN (50% in water) containing 0.05 M NaOH with 25 mL epichlorohydrin followed by reaction at 60 C for 5 hours results in the formation of a viscous liquid. Quenching with ethanol and concentration by evaporation results in an formulation material that can neutralize organic acid substances and act as a sticker.

When crosslinking polymers, epichlorohydrin may be combined with ethylene diamine to enhance the degree of crosslinking. Following reaction of epichlorohydrin with the polymer backbone (as judged either by production of Cl gas, evaporation of epichlorhydrin, or known reaction kinetics) ethylene diamine is added (0.1 to 0.25 molar equivalents of the epichlorhydrin amount used).

### Example 28

### Pesticide Formulations Based on Cellulose Cross-Linked to Other Polymers

Cellulose, either as microcrystalline cellulose or fibrous cellulose powder is brought to a uniform moisture content, usually ca. 50-75%. The cellulose in this paste form is mercerized by mixing with high concentration (30% W/V) NaOH solution. In this example, 100 g of cellulose is brought to 75% water by addition of high resistance (18 Mohm) deionised water and combined with 250 mL 30% NaOH and maintained in a 4 C environment for 60 minutes. To this mixture, 300 mL of epichlorohydrin is added and the mixture then placed in a flask with reflux closure. The mixture is heated by placement on a 90 C water bath and stirred by a mechanical stirring system. Released Cl gas is vented via a fume hood. As the reaction proceeds, the cellulose appears to form yellow clumps. Reaction is enhanced by vigourous mixing using a high speed steel blade to reduce the size of the aggregates and maintain a smooth paste. After 1.5 h, the mixture is washed in twice with 500 ml water and the solids recovered. The settled mixture is further reacted with amine containing functions. In this example, the solids are suspended in a 50 g polyethyleneimine (as 50% solution in water). The mixture is heated to 90 C, stirred using a high speed cutting blade and allowed to react for 2 h. Aggregates formed in this reaction facilitate subsequent washing. Thereafter, the solids are washed in 50% ethanol, then 0.5 M NaOH followed by extensive washes in deionised water until the supernatant is at pH 7.00.

PEI in this example can be replaced by both amine monomers and other polymeric amines (e.g. poly lysine). The amine monomers include those noted in example 1.

### Example 29

Loading of example pesticides to polymers. Polymers as prepared above were loaded with pesticides as follows. The herbicides Imazapyr and Imazamox will serve as examples of representative pesticides. These compounds in the free acid form were prepared as slurries in ethanol (depending on the solubility of the substance, ethanol may be substituted by acetone, MeCN or other water miscible, low boiling, solvents) using an ultraturax (a similar mechanical device may be substituted) to created a uniform suspension. The slurries are added to washed polymer solutions or suspensions in water. The amount of slurry does not exceed 50% V/V of the polymer solution/suspension but may be less depending on the anticipated binding capacity of the polymer.

The combined mixture is blended at high speed to reduce particle size and ensure complete mixing. The mixture is then dried and the recovered dry matter ground to an appropriate particle size—ca. 20 μm to 200 μm.

Following drying, the amount of bound pesticide is quantified as follows (assay processes vary for individual pesticide compounds).

Determination of Freely Soluble A.I.

Weigh between 10 and 20 mg of the dry formulation into a sample tube. Add 3 to 5 ceramic or glass beads to assist in mixing. Add 1 mL of deionised water. Invert twice to ensure that the product is freely suspended. Centrifuge the tubes at 800 rpm for 5 minutes. Remove a sample of the supernatant for spectrophotometry.

Prepare a standard curve with the spectrophotometer using serial dilutions of the A.I. in the appropriate range. Depending on path length and wavelength, this will be approximately between 1 mM and 0.001 mM. The wavelength for reading will depend on the cuvettes employed. For quantitation of most pesticides containing a UV chromophore, A280-330 is adequate. Data collection may be facilitated by using a plate reader and UV transparent microtitre plates.

Determination of Particle Associated or Exchangeable (Salt Extractable) A.I.

Weigh between 10 and 15 mg of the dry formulation into a sample tube (based on a formulation with 10% A.I. content). Add 3 to 5 ceramic or glass beads to assist in mixing. (Alternatively, tubes prepared for the water extraction above may be further extracted as described here.) Add 1 mL of 1 M NaCl in 10 mM NaHPO4 pH 9.0. Place tube in a sonic bath for 30 s and gently shake tube. Centrifuge the tubes at 10000 rpm for 5 minutes (ca. 20000 g). Repeat the process two additional times, collecting the supernatants each time for determination of pesticide concentration by spectrophotometry or mass spectrometry.

Determination of Tightly Bound (Mechanically Extractable) A.I.

Tubes prepared for the water and salt extraction above are further extracted. Add 1 mL of 1 M NaCl in 10 mM NaHPO4 pH 9.0 and place tubes in a heated mixer (we use an Eppendorf heated mixer running at 850 rpm) for 10 minutes at 95 C. Transfer tubes to a bead mill (we use a Savant “Fast Prep” device; 25 s at setting 4.5) and process. For gel formulations, use a 650 mg bead. Centrifuge the tubes at 10000 rpm for 5 minutes (ca. 20000 g) and retain the supernatant. Add salt solution and repeat the process. Then add a suitable organic solvent (ethanol appears adequate) and repeat the process 2 further times without heating.

Based on the proceeding methods, the following loading characteristics were obtained.

| | | | Salt | Mechanically |
|---|---|---|---|---|
| | | Soluble | released | released |
| | Imazapyr | Imazapyr | Imazapyr | Imazapyr |
| Name and summary description | (mmol/g) | (%)* | (%)** | (%)*** |
| DEAE cellulose eg. Example 5 | 0.85 | 36 | 49 | 15 |
| Ecteola cellulose eg. Example 5 | 0.82 | 4 | 45 | 52 |
| Gelatin encapsulated cellulose eg. Example 28 | 0.26 | 39 | 30 | 31 |
| PEI Agar Gel eg. Example 26 and 27 | 1.60 | 29 | 35 | 36 |
| PEI gel eg. Example 27 | 0.55 | 10 | 36 | 54 |
| PEI and 10% PEG 400 eg. Example 27 and 28 | 0.91 | 8 | 30 | 62 |
| PEI saturated with epichlorhydrin as dried | 1.20 | 47 | 29 | 25 |
| particles based on cellulose carrier | | | | |
| eg. Example 28 | | | | |
| Fibrous cellulose linked to PEI and dried from | 0.42 | 14 | 47 | 38 |
| 1% agar solution eg. Examples, 26, 27, 28 | | | | |
| Microcrystalline cellulose covalently linked to | 0.40 | 13 | 54 | 33 |
| PEI and dried from 1% agar solution eg. | | | | |
| Example 26 and 27 | | | | |
| Fibrous cellulose covalently linked to | 0.33 | 33 | 46 | 20 |
| triethyamine, | | | | |
| PEI Agar eg. Example 26 | 1.51 | 73 | 19 | 8 |
| PEI cellulose eg. Example 28 | 0.33 | 27 | 56 | 17 |
| DEAE Cellulose eg. Example 5 | 0.42 | 12 | 68 | 20 |
| Microcrystalline cellulose backbone with | 0.12 | 30 | 54 | 16 |
| triethanolamine eg. Example 5 | | | | |
| Cellulose with triethylamine as the exchanging | 0.39 | 44 | 42 | 14 |
| group eg. Example 5 | | | | |
| Styrene beads substituted with | 0.67 | 4 | 74 | 22 |
| quatemary amine | | | | |
| Cellulose with triethanolamine dried from 1% | 0.18 | 17 | 64 | 19 |
| agar eg. Example 1, 28 | | | | |
| Cellulose diethylamine - example 1 | 0.07 | 9 | 77 | 14 |
| Cellulose dimethylamine - example 1 | 0.07 | 12 | 61 | 27 |
| Cellulose ethylenediamine - example 1 | 0.11 | 13 | 54 | 33 |
| Cellulose triethylamine - example 1 | 0.09 | 11 | 71 | 18 |
| Cellulose triethanolamine - example 1 | 0.06 | 14 | 59 | 27 |
| Cellulose diethylamine - example 28 | 0.12 | 6 | 82 | 12 |
| Cellulose diethanolamine - example 28 | 0.08 | 5 | 74 | 21 |
| Cellulose triethyllamine - example 28 | 0.08 | 2 | 72 | 26 |
| Cellulose triethanolamine - example 28 | 0.10 | 3 | 63 | 34 |
| DEAE Cellulose eg. Example 5 | 0.70 | 26 | 73 | 1 |
| Cellulose PEI - example 28 | 0.49 | 16 | 79 | 5 |
| PEI cellulose agar eg. Example 26, 28 | 0.41 | 21 | 74 | 5 |
| PEI Gel - example 27 | 1.58 | 36 | 61 | 3 |
| | Imazamox in place of imazapyr | | | |
| Chitosan PEI eg. Example 26 | 2.05 | 29 | 69 | 2 |
| Chitosan eg. Example 26 | 1.89 | 57 | 42 | 1 |
| PEI with PVP eg. Example 27 | 3.59 | 50 | 48 | 1 |
| PEI Gel eg. Example 27 | 3.73 | 37 | 62 | 1 |
| Cellulose with PEI and gelatin eg. | 1.97 | 62 | 36 | 2 |
| Example 26, 27, 28 | | | | |
| Cellulose with PEI eg. Example 28 | 2.70 | 57 | 41 | 2 |

*The amount of pesticide released according to each method is recorded as the % of the total bound imazapyr.

### Example 30

Testing of slow release formulations. The formulations described herein may be tested in a number of ways including for general pesticide activity (here and example based on herbicide activity is used) (ie. Formulations described in example 29) in pots with a test plant species, or as seed coats for parasite susceptible (herbicide resistant) crop species.

Briefly, for general herbicide activity, pots are filled with a representative soil (e.g. a loam) and herbicide is added as a suspension of the above formulations in deionised water at a concentration calculated based on pot surface area and intended to correspond to agronomically meaningful rates of application (in this example with Imazapyr, the rate would be between 20 and 2000 g per hectare with optimal data obtained at 600 g per ha equivalent). Seeds of the test species (rye grass is a suitable example but other species may be used) are placed on the soil surface, and the soil is subject to regular simulated precipitation corresponding to a high rainfall area (i.e. 10 mm/day). Growth in pots is cut and pots are reseeded at regular intervals (4-6 weekly) and the residual herbicide activity calculated from the extent of re-growth after each cutting.

Alternatively, maize or similar imidazolinone resistant seed is coated with the formulations using PVP as a sticking agent. The amount of herbicide equivalent used depends on degree of resistance in the seed line but 0.05 to 0.4 mg per seed is a typical amount with 0.1 mg/seed in the dose responsive zone. Seeds are then sown in moist soil and degree of herbicide effect (inversely proportional to extent of slow release) is determined from seedling size.

TABLE 30.1
Relative efficacy at 12 weeks for various formulations of Imazapyr

| | Rating relative to free acid |
|---|---|
| | (+++ = more potent; ++ = |
| Formulation | equipotent; + = less potent) |
| DEAE Cellulose | +++ |
| Quaternary styrene | ++ |
| PEI Cellulose | +++ |
| PEI gel | + |

TABLE 30.2
Relative degree of seedling growth inhibition for formulations of imazapyr

| | Rating relative to free acid |
|---|---|
| | (+++ = more potent; ++ = |
| Formulation | equipotent; + = less potent) |
| PEIPVP gel | ++ |
| PEI Cellulose | + |
| PEI gel | +++ |

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

We claim:

1. A pesticidal formulation, comprising a mixture of:
a single polymer or a mixture of polymers; and
an active pesticidal ingredient.

2. A pesticidal formulation, as in claim 1, wherein the single polymer or said mixture of polymers includes those with repeat structures based on modified cellulose, glucan, starch, dextran, chitosan, chitin fructan and related polymers), lignins, polyhydroxyalkonoates or polymers with repeat units linked by bonds such as esters, amides, ethers, glycols, carbon-carbon bonds, carbon-nitrogen bonds, thiols, or sulfones.

3. A pesticidal formulation, as in claim 1, wherein the single polymer or a mixture of polymers includes at least one biopolymer.

4. A pesticidal formulation, as in claim 1, wherein the single polymer or a mixture of polymers includes only one type of polymer.

5. A pesticidal formulation, as in claim 1, further comprising a water-miscible organic solvent.

6. A pesticidal formulation, as in claim 1, wherein a polymer is an anion exchanger.

7. A pesticidal formulation, as in claim 6, wherein the anion exchanger is conferred by primary, secondary, tertiary, quaternary alkane amines, or bound metals.

8. A pesticidal formulation, as in claim 1, wherein the polymer or polymers is/are a cation exchanger.

9. A pesticidal formulation, as in claim 8, wherein the cation exchange capacity is conferred by carboxy, sulfonic, or bound metals.

10. A pesticidal formulation, as in claim 1, wherein the polymer or polymers is/are capable of hydrophobic interaction.

11. A pesticidal formulation, as in claim 1, wherein the polymer or polymers is/are capable of chelation.

12. A pesticidal formulation, as in claim 1, wherein the polymer or polymers is/are a derivatized cellulose.

13. A pesticidal formulation, as in claim 1, wherein the polymer or polymers is/are a derivatized dextran.

14. A pesticidal formulation, as in claim 1, wherein the polymer or polymers is/are a derivatized chitin.

15. A pesticidal formulation, as in claim 1, wherein the polymer or polymers is/are a derivatized glycol.

16. A pesticidal formulation, as in claim 1, wherein the polymer or polymers is/are a polyimine or polyamine.

17. A pesticidal formulation, as in claim 1, further comprising particles of a size or constitution that can be dispersed or dissolved as a spray formulation.

18. A pesticidal formulation, as in claim 1 further comprising particles of a size that can be dispersed as a broadcast formulation or as a seed treatment.

19. A pesticidal formulation, as in claim 1 further comprising particles of a size that can be dispersed as a row or band application.

20. A pesticidal formulation, as in claim 1 further comprising a coating applied to a plant seed.

21. A pesticidal formulation, as in claim 1 in which the polymeric component acts as a slow release mediator, humectant, sticker, drop size controlling agent, or enhancer of rainfastness in foliar applications.

22. A method for enhancing and/or extending activity of pesticides comprising a combination of pesticide(s) with polymeric formulant(s) as described in claim 1.

23. A method for preventing leaching of pesticides comprising a combination of pesticide(s) with polymeric formulant(s) as described in claim 1.

24. A method for enhancing foliar penetration of pesticides comprising a combination of pesticide(s) with polymeric formulant(s) as described in claim 1.

25. A pesticidal formulation, comprising a mixture of:
a mixture comprising two polymers; and
an active pesticidal ingredient.

26. The pesticidal formulation of claim 25, wherein the weight ratio of said polymer to said active pesticide is not greater than 4:1.

27. A pesticidal formulation, comprising a mixture of
a polymer; and
an active pesticidal ingredient,
wherein the weight ratio of said polymer to said active pesticide is not greater than 4:1.
